(19) United States
(12) Patent Application Publication
(10) Pub. No.: US 2002/0016719 A1
(43) Pub. Date: Feb. 7, 2002

(54) Methods and systems for providing medical data to a third party in accordance with configurable distribution parameters

(76) Inventors: Louis G. Nemeth, Charlotte, NC (US); Russell S. Tuck, Waxhaw, NC (US); Charles E. deKrafft II, Charlotte, NC (US); Charles R. Vanderburg, Waltham, MA (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 09/883,708

(22) Filed: Jun. 18, 2001

Related U.S. Application Data
(63) Continuation-in-part of application No. 09/596,325, filed on Jun. 19, 2000.

(51) Int. Cl. G06F 17/60

(52) U.S. Cl. 705/2

(57) ABSTRACT

Systems and methods are provided to supply medical data to a third party in accordance with a number of configurable distribution parameters. A configurable notification record is provided to define at least one distribution parameter that defines the manner in which medical data is distributed. The distribution parameter may be the third party to be provided medical data, the type of medical data to be provided, the medium over which an alert is to be transmitted and the conditions under which the alert is to be provided. In operation, a wireless communications device receives the medical data from a monitor borne by an ambulatory patient and wirelessly transmits at least some of the medical data to a computer network. Based upon the configurable notification record stored by the computer network, the computer network can transmit the medical data and/or an alert to the third party pursuant to the distribution parameters.

### CROSS-REFERENCE TO RELATED APPLICATIONS

The present application claims priority from U.S. patent application Ser. No. 09/596,325 filed Jun. 19, 2000 by Louis G. Nemeth, et al., the contents of which are incorporated herein in their entirety.

### FIELD OF THE INVENTION

The present invention relates generally to methods and systems for monitoring medical data received from a remotely located patient and, more particularly, to methods and systems for providing the medical data received from a remotely located patient to a third party in accordance with configurable distribution parameters.

### BACKGROUND OF THE INVENTION

In addition to the periodic examination by a physician in the physician's office, it is oftentimes desirable to monitor the medical condition of a patient on a more frequent basis including at times during which the patient is otherwise engaged in normal day-to-day activities. For example, diabetic patients must generally test their blood sugar several times a day. If the blood sugar readings are either abnormally high or abnormally low, the patient can then take appropriate remedial action in order to bring their blood sugar back within the normal range. For example, the patient may administer an insulin shot, drink a glass of orange juice, eat a candy bar or rest for a while in order to allow their blood sugar to return to normal. As another example, patients suffering from various types of heart conditions may need to monitor their blood pressure, pulse rate and the like on a fairly frequent basis throughout the day such that a patient can identify instances in which they should rest and/or relax in order to maintain their blood pressure, pulse and the like at normal levels.

Patients who are both knowledgeable of their medical condition and diligent in monitoring their medical condition can generally identify instances in which remedial action is desirable and then decide upon and institute the appropriate remedial action, such as by adjusting their medication, diet and/or their level of exertion, on an ongoing basis such that they remain in a relatively stable condition. However, a number of patients are either incapable of or unwilling to monitor their medical condition, and then decide upon and institute the appropriate remedial action in order to remain in a relatively stable condition.

For example, a number of children are afflicted with juvenile diabetes. Like adults who are diabetic, children stricken with juvenile diabetes must test their blood sugar several times during a day and must adjust their medication, diet and/or level of exertion in order to maintain their blood sugar at a relatively normal level since failure to maintain their blood sugar at a relatively normal level may cause the child to suffer a diabetic seizure and, over an extended period of time, may lead to blindness, amputation, strokes and even death. Notwithstanding the severe consequences of failing to maintain their blood sugar at a relatively normal level, children oftentimes become preoccupied with other activities and fail to test their blood sugar as frequently as desired. Even in instances in which a child does test his or her blood sugar on a frequent basis, the child may lack the knowledge and experience that is required to determine the remedial steps that should be taken in order to return their blood sugar to a normal level. In addition, a number of elderly patients may be either unable or unwilling to repeatedly monitor their medical condition and to make an educated decision as to whether remedial action is necessary and, if so, what type of remedial action is required in order to remain in a relatively stable condition.

In these situations in which the patient, such as a child or an elderly person, is either unable or unwilling to gather the medical data, interpret the medical data and/or take appropriate remedial actions, a physician, a nurse or other caregiver must intervene in order to remedy the situation. Unfortunately, except in instances in which the patient is hospitalized or is a resident at a nursing home, an extended care facility or the like, the patient is generally remote from the physician, nurse or other caregiver.

In order to obtain the assistance of a physician, a nurse or other caregiver, the patient may be required to visit the physician's office on both a very frequent basis as well as in instances in which abnormal medical data is detected. Even in instances in which the patient promptly goes to the physician's office following the detection of abnormal medical data, some time delay will occur between the detection of the abnormal data and the conference between the patient and the physician. During this time delay, the condition of the patient may worsen since the patient may otherwise fail to take proper remedial action until they have consulted with their physician. This time delay is obviously further exacerbated in instances in which the patient fails to identify an abnormal situation. In addition to the potentially harmful effects to the patient's health occasioned by the failure to remedy the situation until after visiting the physician's office, the patient will incur substantial costs for each office visit, thereby potentially discouraging the patient from visiting the physician as often as otherwise desirable in a misguided attempt to reduce medical costs.

In order to properly treat the patient's condition and to identify the cause of the problem, a physician oftentimes would like to have additional medical data from earlier in the day, the prior day or even before. Even if the patient has been religious in monitoring their medical condition, the patient has likely only collected medical data at a few discrete times throughout the day since the manual collection of medical data at more frequent intervals would likely be too substantial of an imposition into the patient's life. As such, a variety of monitors have been developed for monitoring a number of medical conditions by automatically collecting different types of medical data. For example, glucometers have been developed for automatically monitoring the blood sugar of a patient. Likewise, heart monitors have been developed and are worn by patients to monitor their pulse rate, their heart rhythm and the like. Since these monitors do not require much, if any, attention from the patient, the monitors can collect the medical data of a more frequent basis and can display the medical data for the patient such that the patient can hopefully identify instances in which remedial action should be taken. These monitors also generally include a memory device for storing the medical data for some period of time such that a physician can download the medical data during the patient's visit to the physician's office in order to review at least the recent history of the patient.

In order to permit patients to provide their physician with medical data without having to visit the physician's office, systems have been developed that permit a patient to periodically log onto a computer in their home or office and to then uplink the medical data collected by the monitor to their physician for analysis. Upon analyzing the medical data, the physician can contact the patient if the medical data is abnormal or is approaching abnormal levels in order to ask the patient to either visit the physician at the physician's office for a more thorough examination or to prescribe some remedial action such as by adjusting the patient's medication, diet and pattern of rest and exercise such that the patient's condition will stabilize. While these systems free the patient from having to visit the physician's office as frequently, these systems still impose some delay between the time at which the medical data is collected and the time that the physician analyzes the medical data and suggests remedial action, if necessary. For example, in some of these systems, the monitor that is worn by the patient collects data at fairly regular intervals. The medical data may be uplinked to the physician, however, on a less frequent basis. As such, some delay is introduced between the time of collecting the data and the time of uplinking the medical data to the physician. In addition, even if the data were transferred to the physician immediately following its collection, the physician may not immediately review the medical data that has been uplinked to their computer. Instead, a physician may review the medical data at lunch time, at the end of the day, or during some other break in their otherwise busy day. As such, some additional delays are generally introduced between the time that the data is uplinked to the physician and the time that the physician actually analyzes the medical data and contacts the patient with instructions for appropriate remedial action.

In order to further reduce any delays between the collection of the medical data by the patient and the provision of the medical data to a physician, systems have been developed to transmit the medical data collected by a patient to their physician without requiring the patient to log onto their computer and uplink the medical data to the physician. In this regard, systems have been developed that provide for the medical data to be transmitted from the patient to a computer or computer network that is accessible by the physician while the patient is engaged in their day-to-day activities. For example, the monitor worn by the patient can be configured to wirelessly transmit the medical data to a host computer for transmission to their physician on either a relatively continuous basis or on a periodic basis. In addition, the host computer can analyze the medical data and identify seemingly abnormal medical data. For example, in a system designed to permit a diabetic to transmit their blood sugar readings to their physician, the host computer can be configured to identify instances in which the blood sugar readings are either too high or too low and to provide an alert to the physician such that the physician can more quickly analyze the medical data and contact the patient with an appropriate remedy. In order to facilitate communications between a physician and the patient, some of these systems also provide a communications link between from the physician to the patient such that the physician can transmit messages or actually verbally communicate with the patient in instances in which the physician wishes to prescribe appropriate remedial treatment.

These systems are not only effective in minimizing any time delays between the collection of the medical data and the uplinking of the medical data to the physician, but, at least in instances in which alerts are automatically provided to a physician if abnormal medical data is detected, these systems are also designed to reduce the time delays between the uplinking of the medical data to the physician and the analysis of the data by the physician. Unfortunately, physicians are oftentimes quite busy with other patients or other matters and may not always rush to analyze the uplinked medical data and, even in instances in which an alert is provided, the physician may have to complete another patient visit or the like before attending to the alert. As such, some time delays may still be inherent between the collection of medical data and the analysis of the medical data and the prescription of appropriate remedial action.

Unfortunately, physicians do not spend a substantial amount of time with any one patient, either in person or in the course of periodically reviewing the uplinked medical data. As such, while a physician can certainly identify medical data that is abnormal and can prescribe the traditional treatment for remedying the abnormal condition, the physician may not be as quick to identify trends in the medical data that signify that the patient is starting down a path towards abnormality prior to the medical data actually reaching abnormal levels as would a person who either lives with the patient or otherwise spends a substantial amount of time with the patient. In this regard, a parent may recognize trends in the medical data of their child or an adult child may recognize trends in the medical data of their elderly parent that signify that the patient will subsequently be in need of medical attention, even though the current medical data is not outside of a normal range. In these situations, a person who is more familiar with the patient can instruct the patient to take appropriate remedial action prior to ever reaching the abnormal state, thereby sparing the patient from the potentially ill effects of the abnormal condition. In addition, a person who lives with the patient or otherwise spends a substantial amount of time with the patient may more readily know what types of remedial actions are most appropriate in different circumstances so as to suggest remedial action to the patient that will prove most effective.

As such, while a variety of systems have been developed to facilitate the collection of medical data from a patient and the analysis of the medical data by a physician in a remote location without requiring that the patient visit their physician's office, these systems still have some shortcomings. For example, at least some time delay is generally introduced between the time at which the medical data is collected and the time at which the physician analyzes medical data and prescribes any necessary remedial action. In addition, since these systems are designed to notify a physician, a nurse or other professional caregiver, these systems must rely upon the physician, nurse or other professional caregiver to take time from their otherwise busy schedule in order to analyze the medical data and to prescribe appropriate remedial action. Since physicians, nurses and other professional caregivers are oftentimes quite busy with other patients and other matters and since these physicians, nurses and other professional caregivers do not spend substantial amounts of time with the patient, physicians, nurses and other professional caregivers may not identify trends in medical data as quickly as a person who lives with the patient or who otherwise spends a substantial amount of time with the patient and may not know the particular remedial actions that are most effective for the patient in different situations as would a person who lives with the patient or who otherwise spends a substantial amount of time with the patient.

In addition to medical data relating to the physiological and biological status of a patient, it would also be desirable to monitor other types of medical data including medical data that is not naturally occurring or preexisting within the patient. For example, it would be desirable to monitor and analyze medical data relating to biologically, medically or scientifically relevant drugs, proteins, hormones, molecules, chemicals, atoms, isotopes, compounds or other exogenous materials that are administered or applied to the patient. These materials may be administered or applied to the patient for a wide variety of purposes including the monitoring, diagnosing or treating of the patient, study or research including the study of normal physiology or behavior, the prevention of illness, the enhancement or embellishment of preexisting patient physiology or behavior or risk identification associated with patient physiology or behavior.

As a result of the wide variety of medical data that may be collected and analyzed, the third parties to whom the medical data is distributed may be equally varied and may desirably include pharmaceutical companies, biotechnology companies, research institutions, clinical trial organizations and the like, in addition to or instead of third parties who are responsible for the care of the patient. It would therefore be desirable to have a robust system and method for collecting and analyzing the wide variety of medical data and for selectively distributing information relating to the medical data to selected third parties for any of a variety of purposes. Regardless of the type of medical data and the third party to whom information relating to the medical data will be distributed, it would also be desirable to collect the medical data while the patient is ambulatory. Furthermore, it would desirable to provide alerts, warnings and other information to third parties based upon the medical data collected and analyzed such that the third party will be informed, preferably in real time or near real time, of instances which the medical data meet certain predetermined conditions that merit the immediate attention of the third party.

### SUMMARY OF THE INVENTION

A system and method are therefore provided to supply medical data to a third party in accordance with a number of configurable distribution parameters. The system and method are capable of providing the medical data to any designated third party including entities such as pharmaceutical companies, biotechnology companies, research institutions, clinical trial organizations and the like. In one embodiment, however, the third party is an individual who is responsible for the patient. As such, the patient or a guardian of the patient can tailor the system and the method in such a way that the third party who is provided with the medical data is most knowledgeable about the patient's condition and will be able to analyze and respond to the medical data in a timely manner. In addition, since the medical data can be provided to the guardian of the patient who lives with the patient or otherwise spends a substantial amount of time with the patient and who therefore is likely most knowledgeable about the patient's condition, the guardian can identify trends in the medical data that are a precursor to a medical problem such that appropriate remedial action can be taken in order to prevent the patient from ever reaching the abnormal state.

According to the present invention, a configurable notification record is provided to define at least one distribution parameter that defines the manner in which medical data is distributed wherein the distribution parameter is selected from the group consisting of the third party to be provided medical data, the type of medical data to be provided to the third party, the medium over which an alert based upon the medical data is to be provided to the third party and the conditions under which the alert is to be provided to the third party. In operation, medical data is received from an ambulatory patient. The medical data may be data relating to the physiological or biological status of the patient or may relate to an exogenous material administered to the patient. The medical data may be collected from a single patient or, in one advantageous embodiment, from a plurality of patients, each of whom has a respective monitor that has preferably been properly calibrated. The medical data, information related to the medical data and/or an alert based upon a medical data is then transmitted to the third party who is remotely located from the patient in accordance with the distribution parameters defined by the configurable notification record. For example, the configurable notification record may indicate that the parent of a pediatric patient is to be provided with all of the medical data and that an alert should be provided if the medical data falls outside of a predetermined range or if the rate of change of the medical data exceeds a predetermined value. Alternatively, the configurable notification record may indicate that a research institution is to be provided with the medical data and an alert if the level of a certain protein falls below an preestablished threshold.

In one advantageous embodiment, a wireless communications device, such as a cellular telephone or a personal digital assistant, receives the medical data from a monitor borne by an ambulatory patient and wirelessly transmits at least some of the medical data to a computer network. The computer network typically includes a memory device for storing the configurable notification record such that the computer network can transmit the medical data, an alert or both to the third party in accordance with the distribution parameters defined by the configurable notification record. By permitting wireless transmission of the medical data, a patient can continue their day-to-day activities while the medical data is being collected, transmitted and analyzed pursuant to the notification criteria.

While the wireless communications device can relay all of the medical data in real time or near real time if so desired, a wireless communications device of one embodiment includes a memory device for storing the medical data. If the memory device of the wireless communications device begins to fill, such as in instances in which the portion of the memory device filled with the medical data exceeds a predetermined threshold, the wireless communications device can transmit the medical data to the computer network. If it is determined, however, that the wireless communications device is unable to transmit the medical data to the computer network, the wireless communications device may purge at least some of the data, typically the redundant or otherwise irrelevant data, in order to free memory space for other medical data that has been more recently collected. In addition, the medical data can be analyzed to determine if the conditions under which an alert is to be provided have been met prior to transmitting either the medical data or an alert. In this regard, the wireless communications device may transmit the medical data or an alert even if the memory device has not yet begun to fill if the wireless communications device detects that the medical data meets the conditions established for an alert, such as by falling outside a predetermined range of acceptable values or by having an unacceptably large rate of change.

Along with the medical data, the system and method of the present invention also generally determine the position of the ambulatory patient, especially in instances in which the medical data indicates that an alert is to be provided. As such, the position of the ambulatory patient can be transmitted to the third party concurrent with the transmission of an alert and the underlying medical data.

In addition, the patient can input data relating to factors of import for their medical condition, such as a factor selected from the group consisting of diet, rest, exercise, medication, stress, illness and other activity of the patient. As such, the data input by the patient can also be transmitted to the third party for review and analysis. For example, at least some of the information related to the medical data and at least some of the data input by the patient may be graphically displayed for the third party. Based on the data input by the patient, an alert may be issued if it is determined that the patient has not following the care plan established for the patient.

According to the present invention, all of the medical data can be transmitted to the third party via the wireless communications device and the computer network. The third party can then review the medical data in order to detect trends or the like that may signify that some type of remedial action is advisable. In one embodiment, for example, the medical data is transmitted via the internet such that the third party can view the medical data via a web browser resident upon a computer or other terminal, such as a mobile telephone, accessible by the third party.

In addition to transmitting the medical data and information related to the medical data to the third party, the system and method of the present invention can transmit an alert if it is determined that the medical data meets the conditions established for the generation of an alert. Depending upon the distribution parameters originally configured by the patient or the third party, the alert can be transmitted via a communications technique selected to maximize the likelihood that the third party will receive the alert. In this regard, the communications technique can be selected from the group consisting of an electronic mail message, a telephone call, a digitized telephone message, a pager message, a beeper message and a facsimile transmission. In addition, other parties can be notified in the same or a different manner in order to serve as a back-up to the third party who has primary responsibility for contacting the patient and directing that the patient take appropriate remedial action. Moreover, the system and method of one embodiment can detect patterns in the medical data received from the ambulatory patient and can then heuristically alter at least some of the conditions under which alerts are generated in response to the detected patterns in order to avoid nuisance alerts and the like.

In one embodiment, the system and method monitors the blood sugar of an ambulatory diabetic patient and wirelessly transmits the blood sugar readings to the third party via a wireless communications device, wireless communications network and an associated computer network. Based upon the blood sugar readings as well as any additional factors input by the patient, such as factors relating to the patient's diet, rest, exercise, medication, stress, illness or activity, the third party can determine what, if any, remedial action needs to be taken by the patient. The third party can then contact the patient in order to provide the patient with instructions for the remedial action. In embodiments in which the position of the ambulatory patient is provided along with the medical data, the third party can also visit the patient in order to ensure that the patient has taken the necessary remedial action. While the system and method of the present invention is effective in instances in which the patient is capable of taking the necessary remedial action, there may be instances in which the patient is incapable or unwilling to take the necessary remedial action. For example, in instances in which a diabetic patient is incapable or unwilling to give themselves an injection of insulin, the system and method of one embodiment permits the third party to instruct that insulin is to be administered, which instructions are received by an insulin pump borne by the patient that automatically administers insulin to the patient.

The notification record is typically configured, such as by the patient or the third party, by identifying the third party to whom the medical data is to be distributed and to whom an alert based upon the medical data is to be directed. In addition, the medium over which the alert is to be provided to the third party is preferably identified. As described, this medium can consist of an electronic mail message, a telephone call, a digitized telephone message, a pager message, a beeper message, a facsimile transmission or the like. In addition, the type of medical data to be distributed to the third party is identified. For example, the system and method may be configured to distribute all of the medical data or only the medical data that is received immediately prior to an alert. Additionally, the conditions under which the alert is to be provided to the third party is identified. Thereafter, the communications system over which the medical data and any alerts based upon the medical data will be distributed is configured, typically by defining a notification record having the plurality at distribution parameters identified during the configuration process.

The system and method of the present invention can therefore be configured by the patient or the third party in order to be specifically tailored to the patient's particular situation. In one embodiment, a third party who is familiar with the patient, such as the parent of a young patient or the adult child of an elderly patient, can be provided the medical data and any alerts triggered by an automated analysis of the medical data. Due to their familiarity with the patient, the third party can quickly analyze the data, either on a periodic basis or in response to an alert, to identify any alarming trends in the medical data or any abnormal medical data and can then contact the patient to provide the patient with instructions as to the appropriate remedial action that should be taken. Thus, an abnormal condition can be readily treated and, in many instances, the third party can prescribe remedial action to be taken in advance of the patient actually entering into an abnormal state based upon trends in the medical data and the knowledge of the third party of the medical history of the patient. The system and method can also provide additional data, including the position of the patient and factors typically relating to the diet, exercise, rest, medication, stress, illness or activity of the patient such that the third party can make more educated decisions regarding any necessary remedial action and can locate the patient, if necessary. Further, the system and method can be configured to maximize the possibility that the third party will receive an alert that is triggered based upon an automated analysis of the medical data by permitting the third party to be connected via one or more communications techniques that can be selected based upon the manner in which the third party can most oftentimes be contacted. Alternatively, the third party may be an entity such as a pharmaceutical company, a biotechnology company, a research institution, a clinical trial organization or the like that collects and, in some instances, further processes the medical data provided by the system and method of the present invention for a variety of purposes including research and support of applications for regulatory approval of a new drugs.

### BRIEF DESCRIPTION OF THE DRAWINGS

FIG. 1 is a schematic representation of a system for providing medical data to a third party pursuant to a configurable notification record according to one embodiment of the present invention.

FIG. 2 is a flow chart illustrating the operations performed to provide medical data to a third party pursuant to the configurable notification record according to one embodiment of the present invention.

FIG. 3 is a flow chart illustrating the operations performed to configure the notification record according to one embodiment of the present invention.

FIGS. 4A-4C are images displayed by the system and method of one embodiment of the present invention to provide a third party with information relating to the medical data of the patient.

FIG. 5 is an image displayed by the system and method of one embodiment of the present invention to provide a third party with a listing of alerts that have previously been issued.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

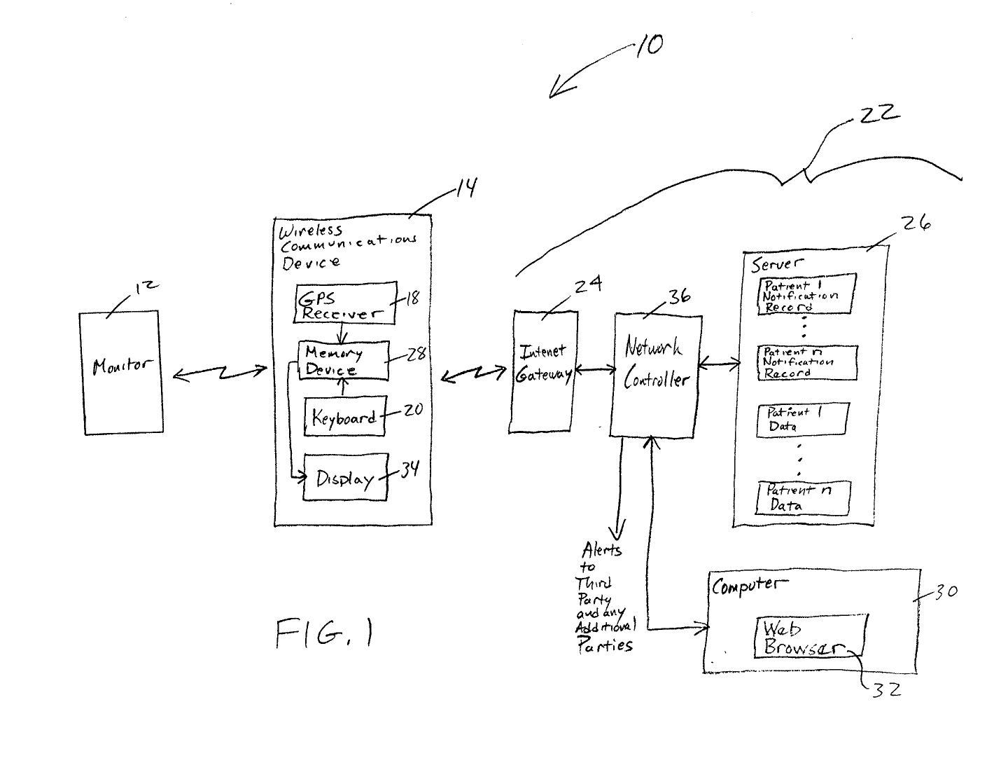

Referring now to FIG. 1, a system 10 for providing medical data to a third party in accordance with a number of configurable distribution parameters is depicted. While the system and method of the present invention will be primarily described hereinafter in conjunction with the monitoring and transmission of the blood sugar readings of a diabetic patient, the system and method can be employed to collect and transmit a variety of different types of medical data. The medical data may relate to the physiological or biological status of a patient, such as a patient suffering from any of a number of medical conditions. For example, the patient can be suffering from a heart condition such that the medical data includes the blood pressure, pulse rate, EKG, EEG and/or other heartrelated parameters. Still further, a patient can be pregnant and the medical data can be the baby's heart rate, blood pressure and the like. By way of further example, the medical data may include the temperature, cholesterol or creatine kinase level of the patient, any data collected from a urinalysis of the patient and/or the HCG of a patient, such as for purposes of pregnancy determination. As such, medical data relating to the physiological or biological status of a patient includes all data relating to the physical condition and composition of the patient.

The medical data collected and analyzed by the system 10 and method of the present invention may also relate to a condition of the patient that is not preexisting or naturally occurring. For example, the medical data can include data relating to biologically, medically or scientifically relevant drugs, proteins, hormones, molecules, chemicals, atoms, isotopes, compounds or other exogenous materials administered or applied to the patient. These exogenous materials may be administered or applied to the patient for various purposes including, for example, the monitoring, diagnosis or treatment of the patient, study or research of a particular condition, prevention of an illness, enhancement or embellishment of preexisting patient physiology or behavior, study of normal physiology or behavior, or risk identification associated with physiology or behavior. For example, a drug, a protein or other exogenous material may be administered to a patient who has been determined to be susceptible to a particular condition or disease, such as breast cancer or osteoporosis, in order to maintain one or more parameters associated with the patient, such as a certain protein level, within a predefined therapeutic range so as to prevent or at least retard the onset of the condition or disease.

By way of more specific example, several illustrations of medical data that is not preexisting or naturally occurring within the patient will be provided. As a first example, a pharmaceutical company may desire to determine the rate at which a newly approved leukemia drug is turned over in obese patients relative to the rate at which the same drug is turned over in non-obese or average-sized patients in order to determine dosage information for the drug. Both patient populations may therefore be given identical doses of the drug and the blood level of the drug may be monitored according to the system and method of the present invention as described below. As such, the medical data in this instance is the blood level of the drug.

As another example, a patient having a broken bone may be given a dietary supplement that increases the natural production of parathormone, a hormone secreted by the thyroid gland that induces the production of new bone mass. Patients with a broken bone that are given the dietary supplement may undergo daily diagnostic tests to monitor new bone deposition at the break site. As such, the medical data in this example may be the new bone deposition and/or the rate of new bone deposition at the break site.

As a further example, the medical data may be the presence and/or concentration of a marker that is indicative of the efficacy of a drug or the like. In this regard, a blood lymphocyte preparation of purified T-cell harvested from blood bank donors (heterologous) or from the patient (homologous) may be processed so as to genetically engineer or modify the T-cells to seek out and destroy the AIDS virus from the cells of a patient who is HIV positive. As such, once the T-cells have been administered to a patient, the modified T-cells will bind to an HIV viral particle so as to produce a cell biological reaction within the modified T-cell which, in turn, produces a small, harmless molecular marker that is released into the patient's blood stream. This marker, such as a protein like luciferase, serves as a signal that the modified T-cells are functioning properly by binding to and destroying HIV viral particles. By monitoring the patient's blood for the presence of the marker, such as for luciferase, according to the system and method of the present invention as described below, it can be determined when the patient requires a new transfusion of modified T-cells or even when the virus has been successfully cleared from the patient's tissues. As such, the marker, such as luciferase, is the medical data in this example.

As the foregoing examples illustrate, the medical data collected and analyzed by the system 10 and method of the present invention not only includes data relevant to the physiological or biological status of a patient that is naturally occurring within the patient, but also data relating to biologically, medically or scientifically relevant drugs, proteins, hormones, molecules, chemicals, atoms, isotopes, compounds or any other exogenous materials administered to or applied to the patient. Additionally, while the system and method of the present invention may advantageously monitor human beings, the system and method may also be utilized to monitor animals in a similar manner. However, for purposes of illustration and not of limitation, the system and method will be hereinafter described primarily in conjunction with a diabetic patient and the blood sugar readings obtained from the diabetic patient.

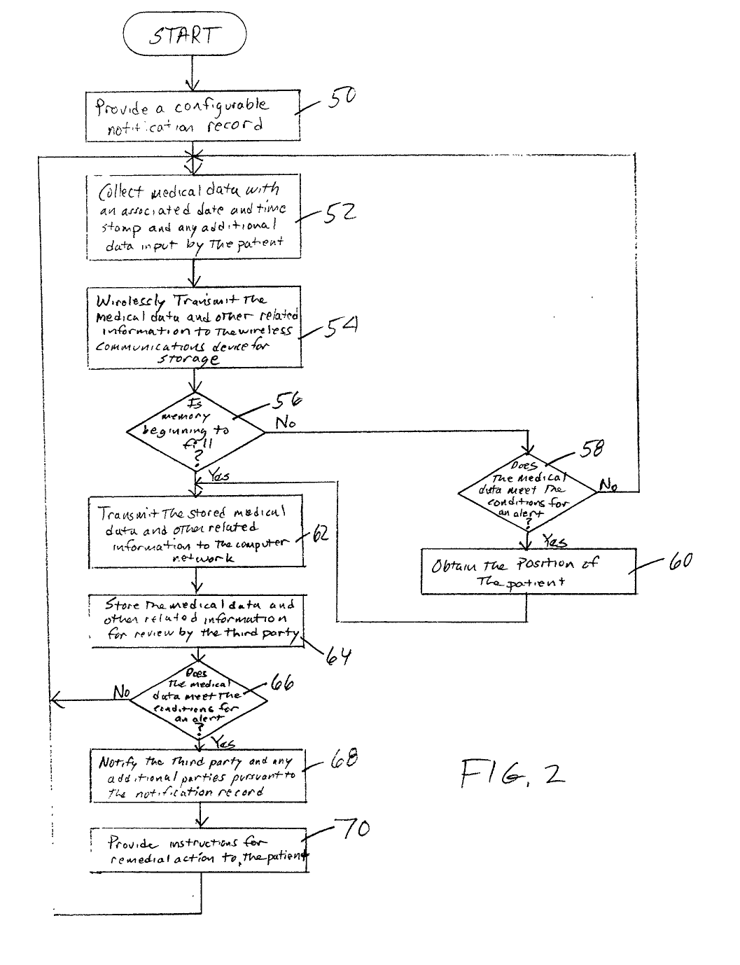

In order to permit the patient to be fully engaged in their day-to-day activities, the patient typically wears or carries a monitor 12 for collecting the medical data. See block 52 of FIG. 2. The monitor can be either invasive or non-invasive. For the diabetic patient, the monitor can be a glucometer for collecting blood sugar readings at periodic intervals throughout the day, such as every 10 seconds. While a variety of glucometers are commercially available, one advantageous type of glucometer is the MiniMed Continuous Glucose Monitoring System provided by MiniMed Inc. of Sylmar, Calif. As will be apparent, other types of monitors would be employed if the patient were inflicted with some other type of medical condition and other kinds of medical data were to be collected. For example, a patient having a heart condition will likely wear a heart Holter monitor. Other types of monitors include, but are not limited to, hypertension monitors, pacemakers, fetal monitors and the like.

In addition to the foregoing examples, the monitor may be any type of sensor, detector, biomonitor or other device that serves to collect the medical data. By way of example, it may be desirable to monitor tumor necrosis factor (TNF) during the clinical trials of an anti-TNF receptor therapeutic compound utilized to treat asthma. In order to monitor TNF, a monitor may be a bio-probe which is an electrochemical device coated with anti-human TNF antibodies as a ligand that binds TNF protein in a patient's saliva and produces an electrical signal which, when amplified, is proportional to the TNF level. By tracking the patient's TNF levels with the bio-sensor, the patient and various third parties may be forewarned of potential asthmatic episodes which may be prevented or reduced in significance by additional anti-TNF therapy, according to the system and method of the present invention as described below. Thus, in this example, the bio-probe serves as the monitor.

By way of another example, a glass detector array can be utilized as a monitor during cancer surveillance procedures. In this regard, there exist a number of situations in which the risk of human cancer is greater than normal. These situations include postoperative situations in which a tumor has been detected and removed, situations involving the diagnosis and treatment of a tumor present in a location that makes surgery impossible or other situations involving high-risk familial and/or hereditary states, particularly at an advanced age. In these situations, it is advantageous to determine if the spread of cancer is occurring in the patient. As such, detection systems have been developed that can monitor the blood of a high-risk patient and detect single cancer cells, if present. One system utilizes a glass detector array that can capture a specific type of cancer cell by binding the cell with an antibody coupled to the detector substrate. This detector utilizes an assay known as the bacterial chain reaction (BCR) to target the cancer cell of a specific alkaline phosphatase (AP)-conjugated ligand, resulting in a florescent signal that can be identified with sensitivity down to a single cell level. Thus, the glass detector array including the BCR assay serves as a monitor in this example. By utilizing these detectors, the blood of a high-risk cancer patient may be constantly surveyed in order to repeatedly measure the number of cancer cells in the blood stream of the patient. Recently, the BCR assay has taken advantage of the germinogenic substrates of the bacteria Bacillus cereus, and may detect a single cancer cell in just 20 to 30 minutes by germinating B. cereus spores in the presence of AP.

As the foregoing examples illustrate, the system and method of the present invention can utilize a wide variety of monitors depending upon the type of medical data being collected. These monitors include radioisotopic, electromechanical, electrochemical, mechanical, antibody-based, flourochromatic, infrared, near infrared flourographic, near infrared tomographic, chemical, thermal, nuclear, electronic, subatomic particle, spectrophotometric, protein micro-array based, DNA micro-array based, RNA micro-array based, microfluidic, cell biological, photonic, oligonucleotide-based, antisense-based, electron capture, mass spectrometric, nuclear magnetic resonance, nuclear magnetic spectroscopic, x-ray, chromatic, enzymatic, positron emission tomographic, microscopic, photographic, photometric, cytometric, MALDI, MALDITOF, chemiluminescent, calorimetric, fluorescent, immunofluorescent, immunohistochemical, interferometric, CCD based, gravitometric and accelerometric detectors, and any combination of the above.

In addition to collecting the medical data, the monitor preferably identifies the patient and the time and date at which each datum was collected, thereby time and date stamping each datum. As used hereinafter, the term “medical data” shall include not only the data collected from the patient, but also any data identifying the patient and any time and date stamp applied to the data.

As depicted in FIG. 1, the system 10 of one advantageous embodiment also includes a wireless communications device 14 for receiving the medical data. The wireless communications device may be incorporated within the monitor 12. For example, the monitor may be a fingerstick glucometer for measuring the blood glucose level of a patient and the wireless communications device may be a two-way paging board that is incorporated within the housing of the fingerstick glucometer or is otherwise attached to or snapped onto the fingerstick glucometer. Typically, however, the wireless communications device is a separate device from the monitor in order to simplify the design of the monitor. As such, the monitor is preferably designed to wirelessly transmit the medical data to the wireless communications device. See block 54 of FIG. 2. Typically, the monitor transmits the medical data to the wireless communications device following the collection of each reading. However, the monitor can include a memory device 16 for storing the medical data and can periodically uplink the medical data collected during a preceding period to the wireless communications device. While the medical data can be wirelessly transmitted from the monitor to the wireless communications device according to a variety of wireless protocols, the medical data is preferably transmitted via a bluetooth instrumentation interface according to the bluetooth protocol that is designed to facilitate short range wireless communications within the Instrumentation, Scientific, Medical (ISM) band at a frequency of approximately 2.4 gigahertz between scientific and medical equipment. Current wireless communications conducted via the bluetooth protocol must be relatively short range, such as within at least 10 meters. However, it is believed that wireless communications conducted via the bluetooth protocol will soon support communications over longer distances such as 100 meters. Further information relating to the bluetooth protocol including the current bluetooth wireless technology specifications are available at www.bluetooth.com as of the time of filing the present application.

While the wireless communications device 14 can be embodied in many different devices, the wireless communications device is oftentimes a communications device that can be easily carried by the patient to ensure that the wireless communications device is within range of the monitor. As such, the wireless communications device can be a cellular telephone, a pager (preferably a two-way pager), a personal digital assistant (PDA), a notebook computer, a handheld computer or the like. However, other types of wireless communications devices can be employed without departing from the spirit and scope of the present invention.

In addition to merely providing the medical data to the wireless communications device 14, at least one of the monitor 12 and the wireless communications device may include means for determining the location of the patient. For example, the wireless communications device may include a global positioning system (GPS) receiver 18 for determining the coordinate position of the ambulatory patient. While the wireless communications device may include a GPS receiver as depicted in FIG. 1, the monitor can include the GPS receiver, in which instance the monitor will provide signals indicative of the position of the patient to the wireless communications device. Alternatively, the system 10 and method of the present invention may include other means for determining the location of the patient with the wireless network that supports wireless communications between the wireless communications device and the computer network 22 providing the patient's location, such as by means of a triangulation technique based upon the respective position of the cellular telephone towers that are relaying the signals between the wireless communications device and the computer network. It should be understood that other means for determining the location of the patient are also within the purview of the present invention.

Additionally, the system 10 of one advantageous embodiment can provide for the entry of additional information by the patient that is relevant to the situation being monitored. In this regard, the wireless communications device 14 typically includes a keyboard 20 or other means for permitting data to be input by the patient, such as by means of selections presented by a menu driven software program. Alternatively, the monitor 12 can include the keyboard or other means for permitting the patient to input information that is then uplinked to the wireless communications device. The system may include other means for permitting the patient to enter additional information including data input by telephone in which instance the patient may dial a unique telephone number and record a voice message with the additional information that may be utilized to annotate the medical data otherwise collected by the monitor.

While the data that is input by the patient will vary depending upon the medical data being collected, the data that is input by a diabetic patient generally relates to the patient's medication, diet and/or the amount of rest and exercise that the patient has had. In addition, the data that is input by the patient may relate to stress, i.e., the occurrence of an unusually stressful situation, the illness of the patient, or a particular activity that the patient undertook. For example, a diabetic patient can enter data relating to their caloric intake, medication that has been taken, the length of any rest periods and the types of exercise performed by the patient as well as the respective times of these events. As explained hereinafter, the data input by the patient can be factored into the analysis performed by the third party in order to properly interpret the medical data.

As also shown in FIG. 1, the medical data received by the wireless communications device 14 is generally transmitted to a computer network 22 for distribution to the third party. In particular, the wireless communications device typically transmits the medical data via radio frequency communications or other wireless means to an internet gateway 24, such as a wireless access point (WAP) or the like, that receives the medical data and provides the medical data to the computer network. As shown in FIG. 1, the computer network typically includes a network controller 36 and an associated server 26, memory device or the like for storing the medical data in a secure fashion for retrieval by the third party in the manner described hereinafter. While the communications between a single patient and the computer network via the respective wireless communications device is depicted in FIG. 1, the computer network is capable of simultaneously communicating with a plurality of patients, i.e., Patients 1 through n as indicated by the records stored by the server in FIG. 1, via respective wireless communications devices and for storing the medical data from each of the patients on one or more servers within the computer network for secure access by respective third parties. In addition to transmitting the medical data, the wireless communications device preferably also transmits any information relating to the position of the patient as well as data input by the patient, such as data related to the patient's diet, rest, exercise, medication, stress, illness or activity. This information is also generally stored by the server along with the medical data from the patient, and is also accessible by the third party as described below.

While the wireless communications device 14 can relay the medical data and all related information to the computer network 22 immediately upon receipt by the wireless communications device from the monitor 12 borne by the ambulatory patient, the wireless communications device typically includes a memory device 28 for storing the medical data and other related information such that the medical data and other related information can be intermittently transmitted to the computer network. While the wireless communications device can be designed to transmit the medical data and other related information to the computer network in response to various predefined conditions, one exemplary embodiment of a wireless communications device will be hereinafter described for purposes of illustration and not of limitation.

In this embodiment, the memory device 28 of the wireless communications device 14 has a predetermined size. As such, the wireless communications device is designed to store the medical data and other information until that portion of the memory device that is filled with the medical data and other related information exceeds a predetermined amount or a predetermined percentage of the memory device. See block 56 of FIG. 2. Once the predetermined amount or the predetermined percentage of the memory device is filled with medical data and related information, the wireless communications device of this embodiment transmits the medical data and other related information to the computer network 22 in order to prevent the memory device of the wireless communications device from ever becoming completely filled and causing newly collected medical data to be lost. See block 62. In addition to transmitting the medical data and other related information as the memory device of the wireless communications device becomes full, the wireless communications device can analyze the medical data to determine if any of the conditions under which an alert is to be provided are met. See block 58. If the wireless communications device determines that the medical data should trigger an alert, the wireless communications device can determine the position of the patient and then transmit the medical data and any related information (including position information) as well as an indication that an alert is to be provided to the computer network even if the memory device of the wireless communications device is not otherwise sufficiently full to trigger the uplinking of the medical data and other information to the computer network. See blocks 60 and 62. As such, the immediate transfer of the medical data and the provision of an alert will minimize any time delays between the collection of abnormal medical data and the notification of the third party, as described below.

The wireless communications device 14 is also preferably designed to differentiate between relevant and irrelevant data and to avoid overwriting the relevant data for as long as possible prior to transmitting the data to the computer network 22. For example, in certain circumstances such as instances in which the patient is onboard an aircraft in flight, the wireless communications device may be unable to open a communications channel to the computer network even though its memory device 28 is near capacity. In this circumstance, the wireless communications device is preferably designed to eliminate or purge irrelevant data and to compact the relevant data to obtain memory space to store the most recently collected medical data. While the wireless communications device can be constructed to differentiate between relevant and irrelevant data in a number of different manners depending upon the type of medical data, the wireless communications device may be designed to delete medical data that is repetitive from one reading to the next so as to only store the medical data and other related information that reflects changes in the medical condition of the patient.

According to the present invention, while access to the medical data stored by the server 26 of the computer network 22 is preferably restricted in order to maintain the integrity and confidentiality of the medical data, the third party who is identified by the configurable notification record described herein below will be provided access to the medical data and all other related information. See block 64. As such, the third party can access the medical data and any other related information on either a relatively continuous basis or according to any time schedule desired by the third party. In one advantageous embodiment, the third party has a computer 30 that is linked to the computer network for accessing the medical data and all other information stored on the server. In this regard, the third party may have a personal computer at home or at the office for accessing the medical data and other related information. Since the medical data is preferably accessible via the internet, the computer of the third party preferably includes a web browser 32 that permits the third party to access the medical data and other related information stored on the server and to display the medical data and other related information in one or more windows on the computer screen. While the third party is generally described herein as accessing the medical data and other related information via a computer, the third party can also access the medical data via a variety of other internet enabled devices or other devices capable of accessing the computer network, such as cellular telephones, PDAs, pagers and the like, any of which may include a web browser for accessing the medical data and other related information stored on the server. As such, each of these devices is intended to be included within the definition of the computer through which the third party accesses the medical data and other related information.

In addition, while the third party can access the medical data and other related information stored on the server 26 for the particular patient with whom the third party is paired, the third party cannot access the medical data or other information stored on the server for other patients, thereby protecting the integrity and confidentiality of the medical data and other information. As such, the computer system 22 serves as a virtual private network for the patient and the third party. In addition, the computer network and, in particular, the server are generally designed such that the third party cannot alter the medical data and other information stored on the server for any patient, including the patient with which the third party is paired, thereby protecting the integrity of the medical data and other information provided by the patients. As such, the patient can maintain a permanent record of their medical data and can permit other parties, such as their physician or other caregiver, to subsequently review the medical data for informational purposes or to confirm that the remedial action taken by the patient was appropriate.

Based upon an analysis of the medical data and other related information, the third party in one embodiment can direct the patient to take remedial action in order to correct an abnormal condition or to otherwise insure that the patient remains in a relatively normal condition. In this regard, since the third party may live with or have substantial contact with the patient, such as in instances in which the third party is the parent of a young patient or the adult child of an elderly patient, the third party may be able to quickly recognize trends in the medical data and to suggest remedial action to prevent the patient from ever reaching an abnormal condition. For example, the third party can identify trends in the blood sugar readings of a diabetic child and can instruct the child to take appropriate remedial action prior to ever becoming either hypoglycemic or hyperglycemic. In addition, the third party may be able to anticipate potential problems and to pay particular attention to the medical data during the relevant time period during which the potential problem would most likely manifest itself in order to promptly identify the onset of the problem and to instruct the patient to take remedial action, if necessary. For example, a parent may have learned that the blood sugar of their diabetic child frequently drops to precariously low levels during the late afternoon. As such, the parent can pay particular attention to the blood sugar readings of their diabetic child from their computer 30 at home or office during the late afternoon and, if the blood sugar readings begin to drop, the parent can contact the child, the school nurse or the like in order to direct the child to have a candy bar or to take other appropriate remedial action in order to raise their blood sugar prior to their blood sugar falling to a precariously low level, thereby avoiding the onset of a hypoglycemia or other disadvantageous complications.

In addition, a third party who either lives with or is otherwise very familiar with a patient may have learned that certain diets or certain patterns of rest and exercise can cause the medical data to change in a somewhat dramatic fashion. By analyzing not only the medical data, but also information relating to the diet, rest, exercise, medication, stress, illness or activity of the patient, the third party may determine that no remedial action is necessary even though the medical data has changed somewhat dramatically by recognizing that the change is attributable to the diet, rest, exercise, stress, illness or other activity of the patient and that the medical data will return to normal levels in the near future without necessitating intervention. Moreover, even if intervention is required in order to remedy an abnormal condition, the data input by the patient can potentially permit the third party to identify the cause of the abnormal condition such that the third party can more accurately determine the appropriate remedial action.

While the system and method of the present invention is advantageous for providing medical data as well as appropriate alerts and warnings to a third party who is responsible for the care of the patient, such as parents, guardians, nurses, health care professionals, physicians and the like, the system 10 and method of the present invention may provide the medical data and any related information including any associated alerts and warnings to a wide variety of other third parties depending upon the application of the system and method of the present invention. For example, the third parties may include pharmaceutical companies, biotechnology companies, research institutions, clinical trial organizations and the like who collect medical data regarding a patient population for a variety of purposes depending upon the mission of the third party. For these third parties, the system typically provides the medical data and other related information to the third party in the form of an electronic file or the like. In order to preserve the confidentiality of the patients, the medical data will commonly be deidentified aggregate data of a population of patients. As such, the term “medical data” will also include the deidentified aggregate data of a population of patients for purposes of this patent application.

As will be apparent to those skilled in the art, the deidentified aggregate data of a population of patients may be utilized for a variety of purposes. For example, a pharmaceutical company may utilize the medical data to determine the reaction of Caucasian males over 40 years of age who live in the southwestern United States to a new drug. In order to further illustrate the variety of third parties to whom the medical data and any related information may be provided, several additional examples are provided.

As a first example, it is been discovered that the daily variations in human body temperature and uncontrolled physical activity can be utilized to differentially diagnose Alzheimer's disease from frontotemporal dementia. This diagnosis can be made long before the onset of dementia or neurodegeneration associated with either disease, thus allowing the physician to embark on the appropriate course of treatment at an earlier stage than previously possible. Additionally, it has been found that treatments that alter a patient's biological rhythms, such as melatonin therapy and light exposure, can actually mediate the symptoms of Alzheimer's disease. However, the baseline temperature and activity data of a patient must be tracked and analyze in order to secure the differential diagnosis as early as possible since treatments that ameliorate Alzheimer's disease are contraindicated in frontotemporal dementia. It is also necessary to continuously monitor the daily temperature and activity variations of a patient throughout treatment in order to sustain a therapeutic window and the concomitant mediation of the disease. Since research is ongoing regarding the differential diagnosis of Alzheimer's disease from frontotemporal dementia, both the physician who is treating the patient and the various schools, hospitals and/or other organizations that are collaborating in the research designed to permit the differential diagnosis of Alzheimer's disease from frontotemporal dementia may be designated third parties who have access to the medical data and any related information, typically in the form of an electronic file of deidentified aggregate data of the population of patients, and who may receive alerts or other warnings that are triggered by the medical data, i.e., the temperature of the patient and the activity data associated with the patient.

By way of a related example, a pharmaceutical company may manufacture a melatonin analog that is more potent and less expensive to produce than melatonin itself. In order to collect the data necessary to support an application for regulatory approval of the melatonin analog, the pharmaceutical company may provide the research group that is conducting the research designed to permit the differential diagnosis of Alzheimer's disease from frontotemporal dementia with the melatonin analog in return for access to the medical data collected by the system and method of the present invention. As such, the pharmaceutical company in this related example would also be a third party capable of accessing the medical data and any related information including any alerts or warnings triggered by the medical data.

As such, while the third party who has access to the medical data and any related information and who receives alerts and warnings based upon the medical data includes the patient as well as third parties responsible, directly or indirectly, for the patient's care and well being, the third party can include a wide variety of other entities including pharmaceutical companies, biotechnology companies, research institutions, clinical trial organizations, computer software companies and the like, to name but a few examples.

The system and method of the present invention can also facilitate communications between the third party and the patient, including the communications link by which the third party may instruct the patient to take certain remedial measures. For example, the third party can input instructions into their computer 30 which are transmitted via the computer network 22 and the internet gateway 24 to the wireless communications device 14, which then identifies the patient. For example, the wireless communications device can include a display 34 upon which the instructions are displayed. In order to attract the attention of the patient, the display of the instructions by the wireless communications device can be accompanied by some other type of notification such as an audible, visual or vibratory alarm. Alternatively, in instances in which the wireless communications device is a cellular telephone or pager, the third party can simply call the patient in order to deliver the remedial instructions, while in instances in which the wireless communications device is a PDA, the third party can transmit the instructions via an email directed to the patient. Still further, in instances in which the position of the ambulatory patient is provided along with the medical data, the third party can actually go to meet the patient in order to deliver the instructions for remedial action or to ensure that the patient has taken appropriate remedial action in response to previously transmitted instructions.

In one embodiment in which the system and method monitor the blood sugar of an ambulatory patient, a third party can provide instructions regarding the administration of insulin to the patient in instances in which the patient's blood sugar has dropped precariously low. In instances in which the patient is wearing an insulin pump or the like, the wireless communications device 14 can provide the instructions to the insulin pump which, in turn, automatically administers to the ambulatory patient without ever requiring that the patient take any remedial action. Obviously, this technique for automatically administering insulin is particularly useful in instances in which the patient is incapable or unwilling to administer the insulin themselves or in situations involving pediatric diabetics who are prohibited from administering their own insulin.

In order to assist the third party in reviewing the potentially voluminous medical data and other related information, the system and method of the present invention can be designed to graphically display the medical data. For example, the medical data can be displayed chronologically with the medical data indexed to the time and date at which the data was collected. In addition, the system and method are preferably designed to permit the third party to access the data in various fashions. For example, the third party may be able to retrieve the medical data that immediately preceded and/or followed an alert or other predefined event, such as a meal, a rest period, an exercise period or the time at which the patient took their medication.

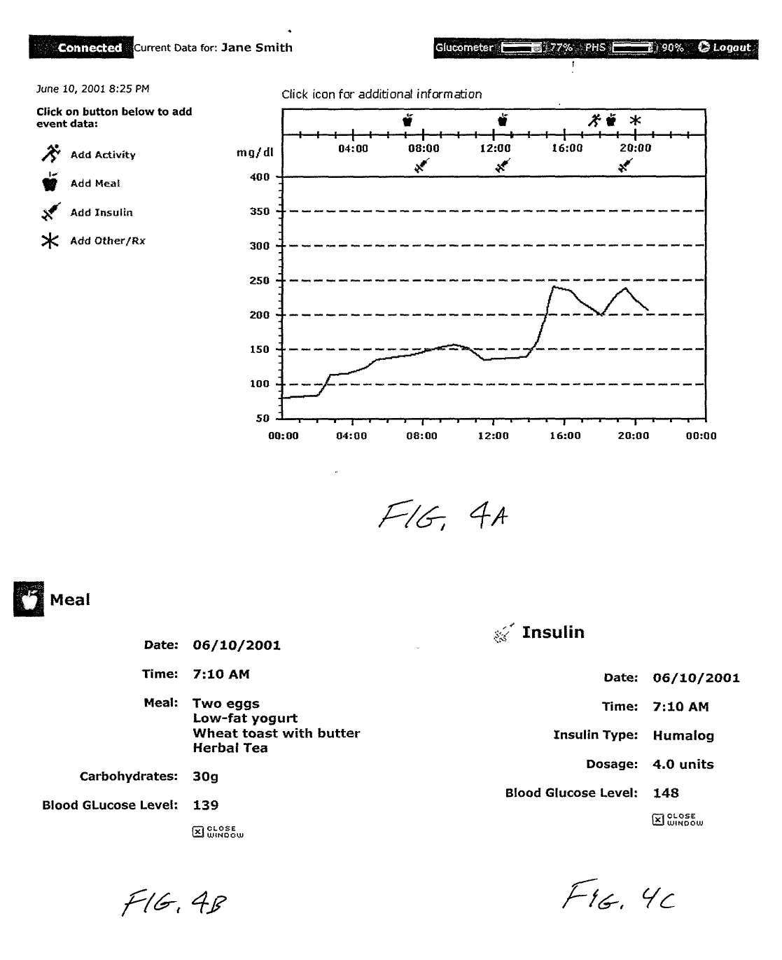

In one advantageous embodiment, the system and method may display icons upon the graphical representation of the data that are indicative of predefined events, such as meals, physical activity or the administration of insulin or other medication, as depicted in FIG. 4A. In one particularly advantageous embodiment, the system and method are designed to provide additional information regarding the predefined event if the third party selects the respective icon, such as by clicking on the icon. With respect to a meal, for example, the system and method may provide information relating to the food that was eaten, the time and date of the meal, the total carbohydrates attributable to the food and the patient's blood glucose level at the time of the meal. See, for example, FIG. 4B. As will be apparent, the monitor can automatically determine the time and date of the meal and the patient's current blood glucose level once the patient inputs information, such as via a keyboard or menu driven software in association with a mouse or other pointing or selection device of the wireless communications device or via telephone or any other technique, indicating that they have had a meal and the food that was eaten and the total carbohydrates attributable to the food. With respect to medication as a further example, the system and method may provide information relating to the type of medication, the dosage amount, the time and date at which the medication was administered and the patient's blood glucose level at the time that the medication was administered. See, for example, FIG. 4C. Still further, in instances in which the patient annotated the medical data with a voice message containing additional relevant information, an icon representative of a telephone may be displayed such that by selecting this icon the audible message containing the additional information that was previously recorded by the patient is replayed.

The system and method may also display other information that may be useful to the third party. For example, the system and method may monitor the battery status of the monitor and the associated wireless communications device and may graphically depict the percentage of battery life that remains or some other measure of the remaining battery power, as shown by the battery icons and associated percentages of FIG. 4A. Additionally, the system and method may provide a continuous indication, such as a blinking icon adjacent to the term “Connected” in FIG. 4A, to signify that a connection is being maintained with the patient such that the third party can be assured that updated medical data will continue to be provided. As the foregoing examples illustrate, the display provided to the third party by the system and method of the present invention can be readily tailored to meet the requirements of the particular application.

The wireless communications device 14 and/or the network controller 36 or various other processing elements of the computer network 22 can also analyze the medical data and compute a variety of statistics depending upon the type of medical data that has been collected. For blood sugar readings, for example, statistics identifying the highest and lowest blood sugar readings in the past 24 hours and the past 30 days can be maintained. In addition, the running average of the blood sugar readings over the past 24 hours can be provided as well as the rate of change of the blood sugar readings. Additional statistics may include the average blood sugar reading after the patient has had a meal containing more than some predetermined amount of carbohydrates, as well as the average blood sugar reading after the patient has slept. The wireless communications device and/or the network controller or various other processing elements of the computer network can also analyze the medical data so as to identify medical data that is in all likelihood incorrect to prevent such data from corrupting the statistics and from causing the third party to instruct the patient to take remedial action based upon erroneous data. In this regard, medical data that changes by more than a predetermined amount or percentage from one reading to the next will generally be removed from further consideration unless subsequent readings are at or near the same level.

In addition to statistically analyzing the medical data, the computer network 22 can collect additional information related to the medical data. For example, since the medical data generally includes a time and date stamp, the computer network can access one or more of the various public weather databases to determine the outside air temperature in the vicinity of the patient at the time that the medical data was collected. This information may be important during the analysis of the medical data by the third party since the temperature may have a significant impact upon the medical data for certain types of patients suffering from certain medical conditions, such as for a pediatric diabetic.

The system and method of one embodiment of the present invention can be designed to be heuristic so as to evolve over time. In this regard, the system and method and, more particularly, the computer network 22 may detect that the medical data changes in much the same fashion at about the same time everyday and may therefore learn to take remedial action in advance of the changes in order to diminish their otherwise deleterious effect. For example, some, but not all, diabetic patients may suffer from predawn syndrome in which their blood sugar drops early in the morning prior to the patient waking. According to this embodiment of the present invention, the system and method can determine that a particular diabetic patient suffers from predawn syndrome by detecting the repeated drop in the patient's blood sugar early in the morning. The system and method can then direct the patient and, more particularly, the insulin pump worn by the patient to supply less insulin during a time period immediately preceding the early morning hours in which the patient's blood sugar typically drops due to predawn syndrome. As such, the supply of insulin will prevent the patient's blood sugar from dropping as much and thereby maintain the patient's blood sugar at a more even level. As another example, a diabetic patient with a glucometer and an insulin pump may remove them before showering every morning. During the shower, the patient's blood sugar will typically rise since the patient is not being supplied insulin and since the temperature of the patient will increase in the warm water. Upon reattaching the glucometer and the insulin pump, the system and method may detect an excessively high rate of change between the blood sugar readings before and after the shower. According to this embodiment of the present invention, however, the system and method can learn that a large rate of change is to be expected in the blood sugar readings shortly after the patient awakes and that the insulin pump will quickly bring the blood sugar back within the normal range without any intervention from a third party. As such, the system and method can learn not to alert the third party in response to the large rate of change in the blood sugar readings since it is an expected event. Obviously, the foregoing examples are but two situations in which the system and method exemplify heuristic behavior and the system and method can evolve in many different manners depending upon the medical data and the design of the system and method.

Moreover, the system and method can be designed to correlate patterns in seemingly unrelated data streams. For example, the system and method and, more particularly, the computer network 22 may determine that the blood sugar readings of a diabetic patient who is outside rise and fall with the outside air temperature. Armed with this correlation, the patient, the third party and/or the patient's physician can respond more appropriately to changes in the patient's medical data by understanding that at least some of the fluctuations may be driven by changes in the outside air temperature.

In addition to merely providing the medical data and other related information for review by the third party, the system and method of the present invention preferably analyze the medical data and provide the third party with an alert if the medical data meets the established conditions for an alert. See blocks 66 and 68 of FIG. 2. While the conditions that trigger an alert will depend upon the type of medical data that is being collected, alerts are typically triggered if the readings are outside of a predetermined range by being either too large or too small or if the rate of change of the readings exceed a predetermined threshold. However, a wide variety of other types of alerts are certainly possible and within the spirit and scope of the present invention. In this regard, the system and method can produce non-compliance alerts if the care plan established for a patient indicates that the patient is to perform a certain activity at a specific time, such as obtaining a blood glucose reading at noon or administering an insulin shot at 1 p.m., and the medical data collected by the monitor, such as in the case of obtaining a blood glucose reading, or entered by the patient, such as in the case of administering an insulin shot, indicates that the patient failed to perform the activity as scheduled.

If the medical data meets the conditions established for an alert, the computer network 22 and, in particular, the network controller 36 will provide an alert to the third party to prompt the third party to quickly review the medical data and other related information and to provide instructions to the patient for any necessary remedial action. In addition, the computer network can provide the third party with the time and date of the alert and the position of the patient at the time of the alert. With respect to the position of the patient, the computer network preferably provides not just the coordinate position of the patient, but a graphical display of a map of the region in which the patient is located with the position of the patient identified thereon. The computer system can provide still further information with the alert, if so desired. For example, the computer network can provide the third party with the URL address of a website at which the third party can obtain additional information about the patient's medical condition or the telephone number of a helpline or hotline that specializes in answering questions regarding the patient's medical condition.

According to the present invention, alerts can be provided via a number of different mediums depending upon the best technique to communicate with the third party. As such, the medium over which the alert is to be transmitted is generally identified during the configuration of the system as described hereinafter. While the alert may be provided to the third party via only a single medium, the alert can be provided via two or more different mediums in order to improve the likelihood that the third party will receive the alert. In addition, a schedule can be provided during the configuration process that defines different mediums that should be used for providing alerts to the third party at different predetermined times of the day or during different days since the best technique for communicating with a third party may change throughout the course of the day or from day to day, i.e., depending upon whether the third party is at work, at home or elsewhere. In addition to providing an alert to the designated third party, the computer network can provide an alert to one or more additional parties, either automatically and concurrent with the alert to the third party or following the alert to the third party and conditional upon the third party failing to respond to the alert. These additional parties therefore serve as back ups and are secondarily responsible for the patient. These additional parties can include physicians, nurses, caregivers or other friends and family of the patient. While the physician, nurse or other caregiver would typically have access to the medical data stored on the server for analysis in order to provide instructions for appropriate remedial action, other parties, such as friends of the family of the patient typically attempt to contact the third party to ensure that the third party is responding to the alert and may be instructed to call or visit the patient in order to ensure that the patient is taking appropriate remedial action.

While a variety of mediums can be utilized to transmit the alert, a communications technique for the alert is typically selected from a group consisting of an electronic mail message transmitted to the third party's computer, PDA or the like, a telephone call, a digitized telephone message, a pager message, a beeper message or a facsimile transmission. However, other types of communications techniques can be utilized without departing from the spirit and scope of the present invention. In instances in which the medical data meet the conditions established during the configuration process for an alert, the wireless communications device 14 is preferably designed to transmit the medical data to the computer network 22 along a signal indicating that an alert should be issued. Upon being notified of an alert, the third party can therefore access all of the medical data and related information from the server 26 in order to quickly analyze the current condition and recent history of the patient and to determine and instruct the patient of the appropriate remedial action. See block 70 of FIG. 2. Included in this analysis may be a review of the data that has been manually entered by the patient, including the patient's diet, rest, exercise, medication, stress, illness or other activity.

The system 10 can be configured to provide the alert on an ongoing basis until the patient or some other authorized representative of the patient, such as the third party, the patient's physician or the like, instructs the computer network 22 that the alert should be terminated. Alternatively, the system may be configured such that the alert is only provided once or a predetermined number of times or is only provided for a predetermined period of time.

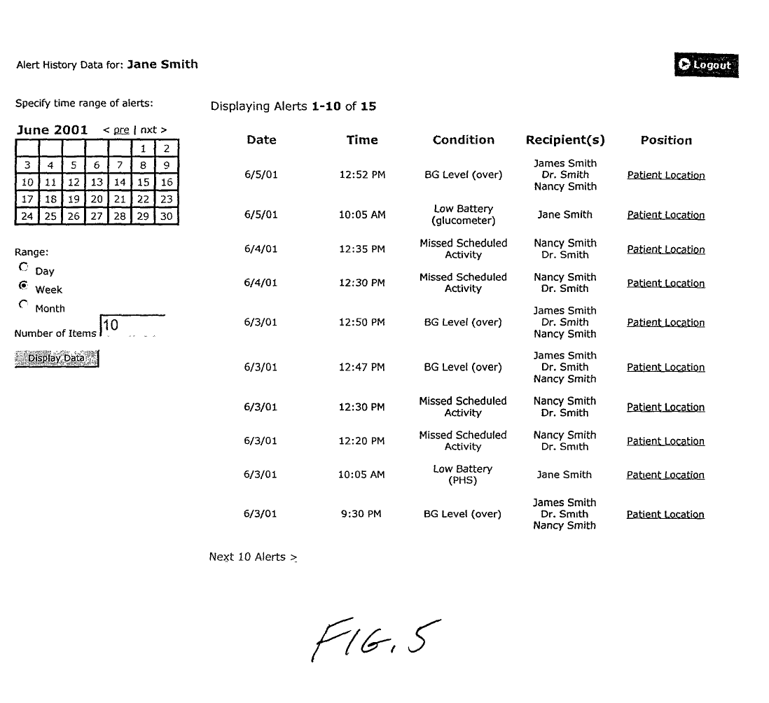

Moreover, the system 10 and method may maintain a listing of the alerts that have been issued including the time and date of the alert, the reason for the alert, the third party or parties to whom the alert was issued and the location of the patient at the time of the alert. As such, the patient or third party can quickly review the alert history, if so desired. See, for example, FIG. 5.

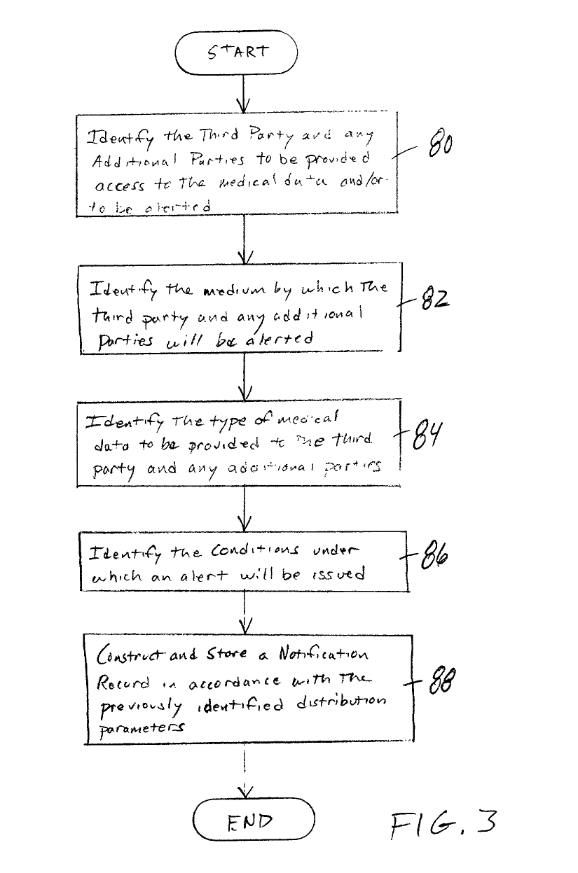

According to the present invention, the notification process is configurable. Although the notification process can be configured by a variety of different people depending upon the design of the system 10, the notification process is typically configured by the patient or a third party, such as the patient's guardian or parent, the patient's physician, nurse or other caregiver or some other entity who is interested in and will have access to the medical data. Typically, the notification process is configured prior to the initial operation of the system, although the notification process can be reconfigured at virtually any time during the operation of the system, if so desired. In order to appropriately configure the notification process, the third party who is to be provided the medical data is typically identified. See block 80 of FIG. 3. As described above, the third party may be the parent or guardian of a young patient or the adult child of an elderly patient. In this application, the third party may be a person who either lives with or has substantial contact with the patient in order to have substantial experience with the medical condition that is being monitored. Alternatively, the third party may be some other entity that is interested in the medical data for any of a wide variety of purposes, such as a pharmaceutical company, a biotechnology company, a research institution, a clinical trial organization and the like, as described above.

The configuration process also permits the type of medical data that is to be provided to the third party to be identified. See block 84. For example, the system 10 can be configured to provide the third party with all of the medical data or with only the medical data that falls within a predefined window immediately preceding and/or following an alert. Still further, the configuration process can identify the conditions under which an alert is to be provided. See block 86. These conditions typically define the range of acceptable readings for the medical data and, in some instances, define the maximum permissible rate of change of the medical data. As such, if the medical data falls outside of these parameters, an alert will be generated as previously described. The configuration process also preferably defines the medium(s) over which an alert is to be provided. As described above, the medium is preferably selected so as to increase the likelihood that the third party will receive the alert and may change throughout the day or from day to day. See block 82. In addition, the system can be configured to notify additional parties of the alert in order to serve as a back-up to the third party, as also described above.

The distribution parameters provided during the configuration process typically define a notification record that is stored by the computer network 22, typically by the server 26 or another memory device as shown in FIG. 1. See also block 88 of FIG. 3.

In addition, at least portions of the notification record are provided to the wireless communications device 14. For example, the conditions under which an alert are to be triggered are typically provided to the wireless communications device such that the wireless communications device can determine instances in which the medical data will trigger an alert and can immediately transmit the medical data and all related information to the computer network for transmission to the third party.

The configuration process may also establish the menus of items to be associated with each of the predefined events, such as meals, physical activity and medication, such that the patient can typically select items from the various menus in order to populate the fields associated with the predefined events, such as type of food, number of carbohydrates, type of medication, dosage amount and the like, in order to simplify the entry of this additional information by the patient. Upon completing or during the configuration process, the system 10 and method of the present invention may also permit the patient or other party responsible for the configuration to preview the display that will be presented to the patient in the field, such as via the wireless communications device 14, to insure that the display is acceptable and understandable to the patient, prior to transmitting the display, i.e., the menu, to the wireless communications device.

The system and method of the present invention can therefore be configured by the patient, the patient's guardian or other third party in order to be specifically tailored to the patient's particular situation. As such, a third party and, in the application involving the monitoring of blood glucose levels, a third party who is familiar with the patient, such as the parent of a young patient or the adult child of an elderly patient, can be provided the medical data and any alerts triggered by an automated analysis of the medical data. Due to their familiarity with the patient, the third party in this application can quickly analyze the data, either on a periodic basis or in response to an alert, to identify any alarming trends in the medical data or any abnormal medical data and can then contact the patient to provide the patient with instructions as to the appropriate remedial action that should be taken. Thus, an abnormal condition can be readily treated and, in many instances, the third party can prescribe remedial action to be taken in advance of the patient actually entering into an abnormal state based upon trends in the medical data and the knowledge of the third party of the medical history of the patient. The system and method can also provide additional data, including the position of the patient and factors typically relating to the diet, exercise, rest, medication, stress, illness or other activity of the patient such that the third party can make more educated decisions regarding any necessary remedial action and can locate the patient, if necessary. Further, the system and method can be configured to maximize the possibility that the third party will receive an alert that is triggered based upon an automated analysis of the medical data by permitting the third party to be connected via one or more communications techniques that can be selected based upon the manner in which the third party can most oftentimes be contacted.

As described above, the third party in other applications may not be an individual who is responsible for the care of the patient, but may be an entity, such as a pharmaceutical company, a biotechnology company, a research institution, a clinical trial organization or the like, that collects the medical data provided by the system and method of the present invention for any of a wide variety of purposes including use of the medical data in support of an application for regulatory approval of a new drug and use of the medical data in a study of the efficacy of a particular drug or treatment protocol. In these applications, the system and method of the present invention may still generate alerts depending upon the conditions defined to generate an alert that were selected during the configuration of the system and method.

Depending upon the application of the system and method of the present invention, the third party may desire not only to review the medical data and any related information, but also to store and further process the medical data or at least portions of the medical data in order to generate additional data and/or statistics related to the medical data. As such, the system and method of the present invention is capable of interfacing with and downloading at least portions of the medical data, typically in the form of an electronic file of the like, to any of a wide variety of downstream information systems including those information systems operated or controlled by third parties such as pharmaceutical companies, biotechnology companies, research institutions, clinical trial organizations or the like for further processing and analysis of the medical data.

By way of example, during a clinical trial for a new therapeutic compound that will be administered to Cystic Fibrosis patients, a third party that is performing the clinical trial may desire to have access to the medical data and to further process the medical data as required for support of its application for regulatory approval of the new therapeutic compound. In this example, the new therapeutic compound is a preparation of avian virus that is sprayed into the lungs of the patients and that infects the pulmonary tissues and produces a human transmembrane receptor (CFTR) in the lung that replaces the nonfunctional variant present in Cystic Fibrosis patients due to genetic mutation. By monitoring the sweat on the skin of the Cystic Fibrosis patients, medical data may be collected by the system and method of the present invention. The medical data may then be transmitted from the computer network 22 of the system of the present invention to a server or other computerized information system at the clinical trial organization, typically in the form of an electronic file containing deidentified aggregate data of a population of patients. The server or other computerized information system of the clinical trial organization may then further process the data to perform the various statistical analyses and reporting that are required to support a new drug application. In this example, the system and method of the present invention may provide an identification code associated with a respective patient along with the date, time of day, time of drug administration, ambient temperature, humidity and patient body temperature in addition to the electrolyte concentrations and pH level gleaned from the sweat-test detector. This medical data may be downloaded to the server or other computerized information system of the clinical trial organization so as to populate a database from which data may be extracted as required for the various statistical analyses and reporting functions necessary to support a new drug application.

As described above, the system and method of the present invention monitors a patient and collects medical data that may be subsequently analyzed in various manners. While the collection of medical data from a single patient has been described for purposes of example, the system and method of the present invention can readily monitor two or more patients in a concurrent manner and may collect the same or different types of medical data from each patient depending upon the configurable notification record associated with each patient. Especially in instances in which the same type of medical data is to be collected from a number of patients, such as during the study of the efficacy of a new drug administered to a number of patients, the monitors borne by the patients are preferably standardized with respect to one another such that the medical data provided by the monitors is also standardized, meaningful, equal and germane to the third parties. As such, the monitors are preferably calibrated prior to and/or during use. For example, the monitors can be calibrated in any manner known to those skilled in the art including by being calibrated at the factory using external or internal reference standards, automatically calibrated using external or internal reference standards, and calibrated or regulated in the field either by remote signaling or data downloads. For example, the monitors may have a self-reporting functionality to provide the system with information relating to the state of calibration, standardization and/or other aspects of instrument performance such that the system and method of the present invention can determine the relative calibration of each monitor and transmit recalibration signals to any monitors that require recalibration while the monitors remain in the field. Once the monitors are properly calibrated, the medical data collected by the various monitors can be more meaningfully analyzed by the system and method of the present invention.

For example, all monitors may be synchronized with respect to time, and an international time zone, by virtue of an internal clock that is reset each day at midnight by a signal transmitted by the computer network 22 to the monitors. As such, medical data, such as body temperature, may be collected from Alzheimer's patients enrolled in a clinical trial of melatonin at precisely 6, 7, 8, 9 and 10 a.m., regardless of time zone, rather than hourly based on each individual monitor's standalone internal clock. Since the monitors are now standardized with respect to one another, the resulting medical data may be provided to the third party and associated with a time of day in manner that is germane to the subsequent analysis to the medical data that may be performed by the third party, i.e., the third party will be assured that the medical data was collected at the desired time.

Further, in the previously described example in which luciferase is detected as an indicator of the activity of a therapeutic T-cell infusion designed to clear HIV from the patient's blood, the luciferase activity measured by an infrared detector is based upon the measurement of the small amounts of light produced by the luciferase substrate. The amount of light produced by the luciferase substrate is somewhat complicated by the fact that the amount of light produced by a given amount to luciferase varies depending upon the pH of the solution in which the luciferase resides, such as the patient's blood. As such, the luciferase detection is preferably corrected for the pH of the patient's blood in order to be an accurate indicator of luciferase activity. By incorporating a pH probe in each monitor along with a correction algorithm that adjusts the measurement of the luciferase activity based upon the pH level of the patient in a predetermined manner, the medical data provided by a plurality of monitors will be correct, equal and meaningful as a result of the standardization process.

As an additional example, monitors designed to detect the pH level are preferably calibrated in order to accurately measure the pH level. As such, prior to being placed in service, the monitors are each calibrated. The monitors would then typically be recalibrated after being placed in service at specific intervals. By being calibrated, each monitor will function within a predetermined and equivalent window of operation in order to provide the accuracy required for the results of the clinical trial to be meaningful. In order to ensure that the monitors remain calibrated during the trial period, the monitors may also include internal reference standards and/or autocalibration protocols for permitting the monitor to repeatedly calibrate itself.

To prevent the medical data collected by the monitors from being corrupted by medical data collected by a monitor that is out of calibration, the system and method of the present invention may identify any monitor that does not operate within a predetermined operating range and may take out or drop the monitor from the network of monitors in order to be re-calibrated or replaced as necessary. While the system and method may detect an improperly calibrated monitor based upon the medical data provided by the monitor, the monitor may also monitor itself and may report itself to be out of calibration. By properly calibrating a plurality of monitors and insuring that the monitors remain calibrated, the system and method of this embodiment of the present invention can concurrently collect the same type of medial data from a number of patients, thereby facilitating the analysis and comparison of the medical data for a variety of purposes as described above.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of providing medical data to a third party pursuant to a configurable notification process, the method comprising:
providing a configurable notification record to define at least one distribution parameter selected from the group consisting of the third party to be provided the medical data, the type of medical data to be provided to the third party, a medium over which an alert based upon the medical data is to be provided to the third party and the conditions under which the alert is to be provided to the third party;
receiving medical data from an ambulatory patient, wherein the medical data is selected from the group consisting of data relating to the physiological or biological status of the patient and data relating to an exogenous material administered to the patient; and
transmitting at least one of medical data, information relating to the medical data and an alert based upon the medical data to the third party located remotely from the patient in accordance with the distribution parameters defined by the configurable notification record.

2. A method according to claim 1 further comprising analyzing the medical data that has been received to determine if the conditions under which the alert is to be provided are met prior to transmitting at least one of the medical data, information relating to the medical data and the alert.

3. A method according to claim 2 further comprising:
determining a position of the ambulatory patient upon determining that the conditions are met for providing the alert; and
transmitting the position of the ambulatory patient to the third party concurrent with the transmission of the alert.

4. A method according to claim 1 wherein transmitting at least one of the medical data, the information relating to the medical data and the alert comprises transmitting the alert via a communications technique selected from the group consisting of an electronic mail message, a telephone call, a digitized telephone message, a pager message, a beeper message and a facsimile transmission.

5. A method according to claim 1 wherein transmitting at least one of the medical data, the information related to the medical data and the alert comprises transmitting the medical data via the internet such that the medical data is capable of being viewed via a web browser accessible by the third party.

6. A method according to claim 1 wherein providing the configurable notification record comprises permitting the notification record to be configured by a person selected from the group consisting of the patient and the third party.

7. A method according to claim 1 further comprising:
receiving data input by the patient relating to a factor selected from the group consisting of diet, rest, exercise, medication, stress, illness and activity, and
transmitting at least some of the data input by the patient to the third party.

8. A method according to claim 7 further comprising graphically depicting both at least some of the information related to the medical data and at least some of the data input by the patient to the third party.

9. A method according to claim 7 wherein transmitting at least one of the medical data, the information related to the medical data and the alert comprises transmitting the alert if the data input by the patient does not comply with a care plan established for the patient.

10. A method according to claim 1 further comprising:
receiving medical data via wireless communications with a wireless communications device from a monitor borne by the ambulatory patient;
transmitting the medical data via wireless communications from the wireless communications device to a computer network for transmission to the third party, and
wherein receiving medical data from the ambulatory patient comprises receiving the medical data onto the computer network from the wireless communications device.

11. A method according to claim 10 further comprising monitoring blood sugar of the ambulatory patient and wirelessly transmitting the blood sugar readings to the wireless communications device.

12. A method according to claim 11 further comprising:
receiving instructions from the third party regarding administration of insulin in response to an alert; and
automatically administering insulin to the ambulatory patient in response to the instructions from the third party.

13. A method according to claim 10 further comprising analyzing the medical data received by the wireless communications device prior to transmission of the medical data to the computer network, wherein analyzing the medical data comprises determining if the conditions under which the alert is to be provided are met.

14. A method according to claim 13 wherein transmitting the medical data from the wireless communications device to the computer network comprises transmitting the medical data upon determining that the conditions under which the alert is to be provided are met.

15. A method according to claim 10 wherein the wireless communications device comprises a memory device for storing the medical data, and wherein transmitting the medical data from the wireless communications device to the computer network comprises transmitting the medical data once the portion of the memory device filled with the medical data exceeds a predetermined threshold.

16. A method according to claim 10 further comprising:
storing the medical data received from the monitor prior to transmission to the computer network;
determining that the wireless communications device is presently unable to communicate with the computer network; and
purging at least some of the medical data such that more recent medical data can be stored by the wireless communications device.

17. A method according to claim 1 wherein receiving medical data from the patient comprises receiving medical data from a plurality of patients.

18. A method according to claim 1 further comprising processing the information related to the medical data following transmission to the third party.

19. A method according to claim 1 further comprising:
detecting patterns in the medical data received from the ambulatory patient; and
heuristically altering at least some of the conditions under which alerts are generated in response to the detected patterns.

20. A system for providing medical data to a third party in accordance with configurable distribution parameters, the system comprising:
a wireless communications device for receiving medical data from a monitor borne by an ambulatory patient and for transmitting at least some of the medical data, wherein the medical data is selected from the group consisting of data relating to the physiological or biological status of the patient and data relating to an exogenous material administered to the patient;
a computer network for receiving the medical data transmitted by said wireless communications device, said computer network comprising a memory device for storing a configurable notification record to define at least one distribution parameter selected from the group consisting of the third party to be provided the medical data, the type of medical data to be provided to the third party, a medium over which an alert based upon the medical data is to be provided to the third party and the conditions under which the alert is to be provided to the third party, and
wherein said computer network also transmits at least one of the medical data, information related to the medical data and an alert based upon the medical data to the third party located remotely from the patient in accordance with the distribution parameters defined by the configurable notification record.

21. A system according to claim 20 wherein said wireless communications device analyzes the medical data that has been received from the monitor to determine if the conditions under which the alert is to be provided are met prior to transmitting the medical data to the computer network.

22. A system according to claim 21 wherein said wireless communications device transmits the medical data to said computer network upon determining that the conditions under which the alert is to be provided are met.

23. A system according to claim 22 wherein said wireless communications device comprises means for determining a position of the ambulatory patient.

24. A system according to claim 23 wherein said means for determining the position of the ambulatory patient once said wireless communications device determines that the conditions are met for providing the alert, and wherein said wireless communications device transmits the position of the ambulatory patient to the computer network concurrent with the medical data.

25. A system according to claim 20 wherein said wireless communications device comprises a memory device for storing the medical data, and wherein said wireless communications device transmits the medical data to said computer network once the portion of the memory device filled with the medical data exceeds a predetermined threshold.

26. A system according to claim 20 wherein said computer network further comprises an internet-accessible device including a web browser accessible by the third party for permitting the third party to view the medical data.

27. A system according to claim 20 wherein said computer network transmits the alert via a communications technique selected from the group consisting of an electronic mail message, a telephone call, a digitized telephone message, a pager message, a beeper message and a facsimile transmission.

28. A system according to claim 20 wherein said wireless communications device and said computer device cooperate to permit the notification record to be configured by a person selected from the group consisting of the patient and the third party.

29. A system according to claim 20 wherein said wireless communications device is adapted to receive data input by the patient relating to a factor selected from the group consisting of diet, rest, exercise, medication, stress, illness and activity, and wherein said wireless communications device is adapted to transmit at least some of the data input by the patient to said computer network for transmission to the third party.

30. A system according to claim 29 wherein said computer network is adapted to provide a graphical depiction to the third party of both at least some of the information related to the medical data and at least some of the data input by the patient.

31. A system according to claim 29 wherein said computer network is adapted to transmit the alert if the data input by the patient does not comply with a care plan established for the patient.

32. A system according to claim 20 further comprising a plurality of wireless communications devices for receiving medical data from respective patients and for transmitting at least some of the medical data to said computer network.

33. A system according to claim 20 wherein said wireless communications device is selected from the group consisting of a cellular telephone and a personal digital assistant.
